(19) United States
(12) Patent Application Publication
(10) Pub. No.: US 2016/0022380 A1
(43) Pub. Date: Jan. 28, 2016

(54) WIRED-MOUTH-PROTECTION MEDICAL DEVICE

(71) Applicant: Kelly M. Putnam, Goodrich, MI (US)

(72) Inventor: Kelly M. Putnam, Goodrich, MI (US)

(21) Appl. No.: 14/462,797

(22) Filed: Aug. 19, 2014

Related U.S. Application Data
(60) Provisional application No. 61/999,211, filed on Jul. 22, 2014.

(51) Int. Cl. A61C 5/14

(52) U.S. Cl. CPC A61C 5/14

(57) ABSTRACT

A wired-mouth-protection medical device comprises at least one flexible material pad that defines a pair of opposed faces and is configured to be positioned between and in operative resting contact with teeth and gums of a surgical patient and surgical hardware attached to the teeth and/or gums. In this way, the pad wraps about a front of top and bottom sets of the teeth and gums in a “wired mouth” state of the patient and acts as a barrier between at least one surgical wound of the teeth and/or gums and the surgical hardware. The pad defines further an air hole that is configured to allow the patient to breathe through the pad.

### CROSS-REFERENCE TO RELATED APPLICATION

This application is based upon and claims benefit of the filing date of U.S. Provisional Patent Application 61/999,211 filed on Jul. 22, 2014 and entitled “mouth guard aka wire mouth protection.”

### BACKGROUND OF INVENTION

1. Field of Invention

The invention relates, generally, to a medical device and, more particularly, to such a device for protection of a wired mouth of a convalescing oral- or maxillofacial-surgery patient.

2. Description of Related Art

The interior of the mouth—particularly, tissue and gums thereof—of a patient of oral or maxillofacial surgery is generally cut, scraped, and otherwise injured. As such, the mouth is typically sensitive after the surgery. As part of post-surgery oral-care protocol, to protect the mouth after the surgery, the mouth is often hardware-wired. More specifically, pesky wire and other hardware are attached to the teeth of the patient. Also, the hardware is covered with a paraffin-wax material, such as bone wax. The wired mouth is discomforting.

With this protocol, although the mouth is protected, it still needs to be comforted, relieved, and soothed of the injuries. Furthermore, the patient may highly resist the coverage of the paraffin-wax material because the material may be dislodged from the hardware over time. In addition, small bits of the material can migrate to the throat of the patient and, in turn, induce gagging of the patient. This can result in panic and suffocation of the patient, thereby forcing emergency cutting of the hardware.

Thus, there is still a need for improved protection of a wired mouth of a convalescing oral or maxillofacial-surgery patient. More specifically, there is a need for such protection that comforts, relieves, and sooths the injuries. There is a need for such protection that also the patient does not resist. In particular, there is a need for such protection that may not be dislodged from the hardware over time. There is a need for such protection also small bits of which cannot migrate to the throat of the patient. There is a need for such protection that also does not induce gagging of the patient. There is a need for such protection that does not also result in panic and suffocation of the patient. There is a need for such protection that does not also force emergency cutting of the hardware.

### SUMMARY OF INVENTION

The invention satisfies these needs in a wired-mouth-protection medical device. The medical device includes at least one flexible material pad that defines a pair of opposed faces and is configured to be positioned between and in operative resting contact with teeth and gums of a surgical patient and surgical hardware attached to the teeth and/or gums. In this way, the pad wraps about a front of top and bottom sets of the teeth and gums in a “wired mouth” state of the patient and acts as a barrier between at least one surgical wound of the teeth and/or gums and the surgical hardware. The pad defines further an air hole that is configured to allow the patient to breathe through the pad.

The medical device of the invention improvingly protects a wired mouth of a convalescing oral or maxillofacial-surgery patient.

The medical device comforts, relieves, and soothes the wired mouth of existing cuts, injuries, scrapes, etc. on various locations of the gums.

The patient does not resist the medical device.

The medical device also may not be dislodged from the hardware over time.

Small bits of the medical device cannot migrate to the throat of the patient.

The medical device also does not induce gagging nor result in panic and suffocation of the patient nor force emergency cutting of the hardware.

The medical device also provides immediate relief of pain from the wired mouth and lessens the amount of discomfort suffered by the patient while he/she convalesces.

The medical device provides also improved hygiene and quality of life to the patient.

The medical device also is simple and effective.

The medical device is also water-resistant to act as a repellant barrier to touching by unwanted liquids to cuts, scrapes, and other injuries of the mouth.

The medical device also assists in dissemination of liquids—namely, promotes migration of liquefied nutrition and pushing of saliva to a rear of the mouth to prevent drooling by the patient.

The medical device also can be easily, quickly, and versatilely installed in the mouth and easily modified to be custom-fit in the mouth.

The medical device also ensures easy breathing of the patient.

The medical device also assists in keeping the mouth clean and sanitary during healing of the mouth such that recovery of the patient is faster and more successful.

With the medical device, there is no build-up of waxes or gels when the mouth is unwired, yielding hygienic results after removal of the hardware.

The medical device can also be cut to shape and used in different locations of the mouth where comfort is especially needed.

The medical device can also hinder or even prevent any acid from food and/or drink from burning gums of the patient.

The medical device can also be used by surgeons after surgery by packing the medical device into the mouth of the patient for immediate comfort thereof and/or absorption of blood therein.

Those having ordinary skill in the related art should readily appreciate objects, features, and advantages of the wired-mouth-protection medical device of the invention as it becomes more understood while the subsequent detailed description of embodiments of the medical device is read taken in conjunction with an accompanying drawing thereof.

### BRIEF DESCRIPTION OF EACH FIGURE OF DRAWING OF INVENTION

FIG. 1 is an environmental view of an embodiment of a wired-mouth-protection medical device according to the invention showing the medical device being employed for protection of a wired mouth of a convalescing oral- or maxillofacial-surgery patient.

FIG. 2 is a front or rear view of the embodiment of the wired-mouth-protection medical device according to the invention illustrated in FIG. 1.

FIG. 3 is a top or bottom view of the embodiment of the wired-mouth-protection medical device according to the invention illustrated in FIG. 1.

### DETAILED DESCRIPTION OF EMBODIMENTS OF INVENTION

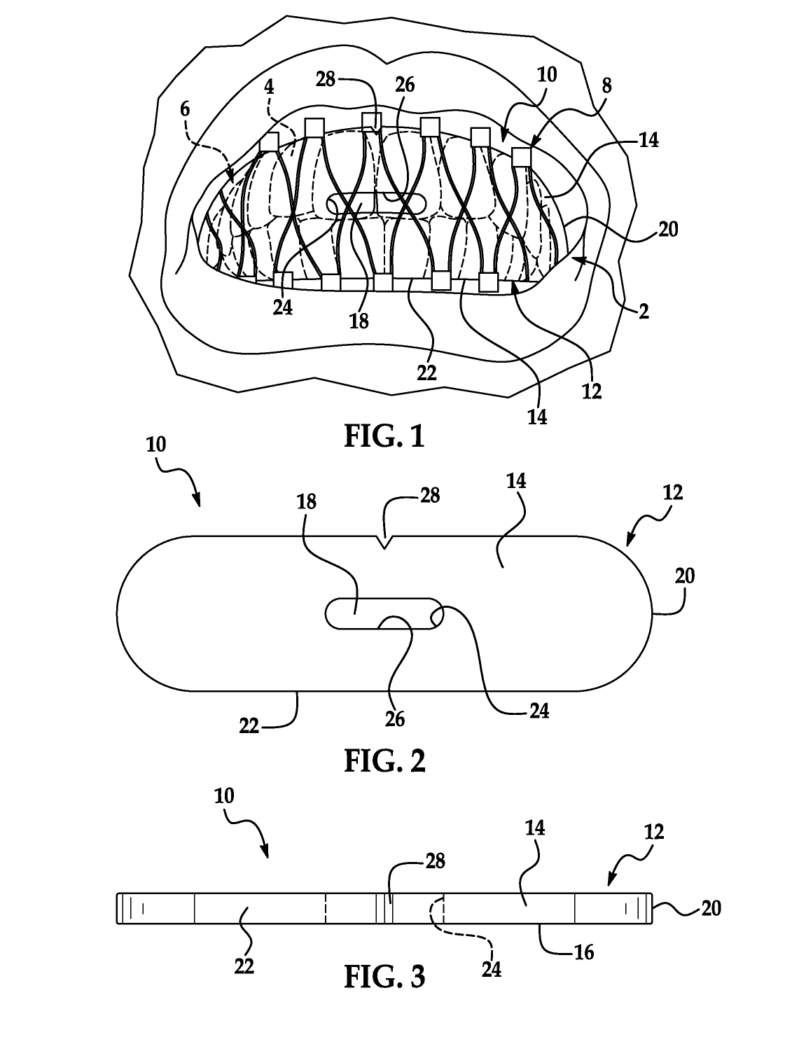

Referring now to the figures, throughout which like numerals are used to designate like structure, an embodiment of a wired-mouth-protection medical device according to the invention is generally indicated at 10. Although the medical device 10 is described and shown herein employed for protection of a wired mouth, generally indicated at 2 in FIG. 1, of a convalescing oral- or maxillofacial-surgery patient, it should be appreciated by those having ordinary skill in the related technology that the medical device 10 can be employed for protection of a non-wired mouth. It should be so appreciated also that the medical device 10 can be employed with any suitable type of patient.

The medical device 10 includes, in general, at least one flexible material pad, generally indicated at 12, that defines a pair of opposed faces 14, 16. The pad 12 is configured to be positioned between and in operative resting contact with, as shown in FIG. 1, teeth 4 and gums, generally indicated at 6, of a surgical patient and surgical hardware, generally indicated at 8, attached to the teeth 4 and/or gums 6. In this way, the pad 12 wraps about a front of top and bottom sets of the teeth 4 and gums 6 in a “wired mouth” state of the patient and acts as a barrier between at least one surgical wound of the teeth 4 and/or gums 6 and the surgical hardware 8. The pad 12 defines further an air hole 18 that is configured to allow the patient to breathe through the pad 12.

More specifically, in an embodiment of the medical device 10, the pad 12 is substantially rectangular, but defines opposed, substantially identical and arcuate exterior ends 20. As such, the pad 12 defines opposed, substantially identical and linear exterior sides 22 that are substantially parallel with respect to each other, and the exterior ends 20 are concave with respect to each other. In this way, a shape of the pad 12 is similar to that of an adhesive bandage. The pad 12 also wraps about a significant portion—approaching an entirety—of the front of the top and bottom sets of the teeth 4 and gums 6. A width of the pad 12 is sufficient to cover the teeth 4 and at least a significant portion of the gums 6. A thickness defined by the pad 12 is small relative to each of a length and the width defined by the pad 12. In an aspect of the embodiment, the thickness of the pad 12 is substantially uniform. The pad 12 is also pillowy to act as a pillow upon which the gums 6 can rest. In an aspect of the embodiment, only one of the faces 14, 16 is pillowy. In an alternative aspect, both of the faces 14, 16 are pillowy. In either of these aspects, only a part or an entirety of the face(s) 14, 16 can be pillowy.

Also in the embodiment, at least one of the faces 14, 16 of the pad 12 is water-resistant. In this way, the medical device 10 acts as a repellant barrier to touching by unwanted liquids to cuts, scrapes, and other injuries of the mouth 2 and assists in dissemination of liquids—namely, promotes migration of liquefied nutrition and pushing of saliva to a rear of the mouth 2 to prevent drooling by the patient. In an aspect of the embodiment, only one of the faces 14, 16 is water-resistant. In an alternative aspect, both of the faces 14, 16 are water-resistant. In either of these aspects, only a part or an entirety of the face(s) 14, 16 can be water-resistant.

Also in the embodiment, the pad 12 includes a soft, soothing material—such as velvet and/or foam—that is in operative contacting relationship with the gums 6. In this regard, only a part or an entirety of the pad 12 can include velvet and/or foam. With respect to the foam, the foam includes medical foam in an aspect and latex foam in an alternative aspect.

In this context, some materials—e.g., plastic, silicone, and wax—are not conducive to be used in the pad 12. For example, wax can cause small particles thereof to float in the mouth 2, which can cause gagging and/or risk of choking of the patient.

In an alternative embodiment, the medical device 10 comprises a pair of pads 12. Toward that end, the pads 12 are disposed in a “back-to-back” relationship with each other.

It should be appreciated by those having ordinary skill in the related technology that the pad 12 can have any suitable shape, size, and structure. For example, the pads 12 can be cut to shape. It should be so appreciated also that the pad 12 can define substantially linear exterior ends 20. It should be so appreciated also that the pad 12 can wrap about any suitable length of the front of the top and bottom sets of the teeth 4 and gums 6. It should be so appreciated also that the thickness of the pad 12 can be non-uniform such that a thickness of any particular part of the pad 12 can be greater or lesser than that of any other particular part of the pad 12. It should be so appreciated also that the face(s) 14, 16 can be made pillowy by any suitable method and material(s). It should be so appreciated also that the face(s) 14, 16 can be made water-resistant by any suitable method and material(s). It should be so appreciated also that the pad 12 can include any suitable type of velvet and/or foam.

Also in the embodiment, the air hole 18 is defined in a substantially central area and through an entirety of the pad 12. The air hole 18 is also substantially rectangular, but defines opposed, substantially identical and arcuate interior ends 24 of the pad 12. As such, the air hole 18 defines opposed, substantially identical and linear interior sides 26 of the pad 12 that are substantially parallel with respect to each other, and the interior ends 24 are concave with respect to each other. In this way, a shape of the air hole 18 is similar to that of the pad 12 and, hence, an adhesive bandage.

The air hole 18 is also substantially concentric, congruent (such that a length of the air hole 18 is defined along the pad 12), and symmetrical with respect to the pad 12. In this way, the interior sides 26 of the pad 12 are substantially parallel with the exterior sides 22 of the pad 12, the interior ends 24 of the pad 12 are substantially parallel with the corresponding exterior ends 20 of the pad 12, the interior sides 26 of the pad 12 are substantially equidistant to the corresponding exterior sides 22 of the pad 12, and the interior ends 24 of the pad 12 are substantially equidistant to the corresponding exterior ends 20 of the pad 12. In an aspect, a surface area defined by the air hole 18 is small relative to that defined by the pad 12. In the illustrated embodiment, a width of the air hole 18 is substantially similar in size as that of the thickness of the pad 12.

It should be appreciated by those having ordinary skill in the related technology that the air hole 18 can have any suitable shape and size. It should be so appreciated also that the air hole 18 can be defined through any suitable thickness of the pad 12. It should be so appreciated also that the air hole 18 can have any suitable relationship with the pad 12.

Also in the embodiment, the medical device 10 defines at least one indentation 28 that is configured to receive a corresponding frenulum of the patient—namely, the frenulum labii superioris (which is located at or near an uppermost, substantially central area of the gums 6 inside the upper lip of the patient) or frenulum labii inferioris (which is located at or near a lowermost, substantially central area of the gums 6 inside the lower lip of the patient). Toward that end, in the illustrated embodiment, the indentation 28 is defined in an uppermost, substantially central area of the pad 12. The indentation is also substantially triangular (tapering toward the air hole 18) and symmetrical with respect to the pad 12 and, in turn, air hole 18. In an aspect, a surface area defined by the air hole 18 is large relative to that defined by the indentation 28. In the illustrated embodiment, a depth of the indentation 28 is less than the thickness of the pad 12.

It should be appreciated by those having ordinary skill in the related technology that the indentation 28 can have any suitable shape and size. It should be so appreciated also that the indentation 28 can be defined through any suitable thickness of the pad 12. It should be so appreciated also that the indentation 28 can have any suitable relationship with the pad 12. It should be so appreciated also that the medical device 10 can define another indentation 28 that is configured to receive the frenulum labii inferioris. In such case, it should be so appreciated also that the indentations 28 can be opposed and substantially identical, “mirror” images with respect to each other.

In operation of the medical device 10 on a convalescing patient of oral or maxillofacial surgery, the pad 12 is placed between at least one cut, scrape, and/or other injury of gums 6 and/or teeth 4 of the interior of the sensitive mouth 2 of the patient and surgical hardware 8 attached to the teeth 4 and/or gums 6. (By way of example only, the surgical hardware 8 can be uncomfortable wire 8. However, those having ordinary skill in the related technology should appreciate that the surgical hardware 8 can be any suitable uncomfortable hardware 8.) In this way, one of the faces 14, 16 operatively rests in contact with the cut(s), scrape(s), and/or other injury or injuries while the other face 14, 16 operatively rests in contact with the wire 8. Consequently, the pad 12 wraps about the front of the top and bottom sets of the teeth 4 and gums 6 and acts as a barrier between the cut(s), scrape(s), and/or other injury or injuries and the wire 8. The frenulum labii superioris is received in the indentation 28, and the patient breathes through the air hole 18. As part of post-surgery oral-care protocol, the medical device 10, among other things, comforts, relieves, and soothes the wired mouth 2 of injuries after the surgery.

It should be appreciated by those having ordinary skill in the related technology that the medical device 10, in general, and pad(s) 12, in particular, can be made of any suitable material. It should be so appreciated also that the medical device 10 can be produced by any suitable method or procedure.

The medical device 10 improvingly protects the wired mouth 2 of a convalescing oral or maxillofacial-surgery patient. Also, the medical device 10 comforts, relieves, and soothes the wired mouth 2 of existing cuts, injuries, scrapes, etc. on various locations of the gums 6. And, the patient does not resist the medical device 10. Furthermore, the medical device 10 may not be dislodged from the hardware 8 over time. In addition, small bits of the medical device 10 cannot migrate to the throat of the patient. Moreover, the medical device 10 does not induce gagging nor result in panic and suffocation of the patient nor force emergency cutting of the hardware 8. Plus, the medical device 10 provides immediate relief of pain from the wired mouth 2 and lessens the amount of discomfort suffered by the patient while he/she convalesces. The medical device 10 provides improved hygiene and quality of life to the patient as well.

The medical device 10 is simple and effective. Also, the medical device 10 is also water-resistant to act as a repellant barrier to touching by unwanted liquids to cuts, scrapes, and other injuries of the mouth 2. And, the medical device 10 assists in dissemination of liquids—namely, promotes migration of liquefied nutrition and pushing of saliva to a rear of the mouth 2 to prevent drooling by the patient. Furthermore, the medical device 10 can be easily, quickly, and versatilely installed in the mouth 2 and easily modified to be custom-fit in the mouth 2. In addition, the medical device 10 ensures easy breathing of the patient. Moreover, the medical device 10 assists in keeping the mouth 2 clean and sanitary during healing of the mouth 2 such that recovery of the patient is faster and more successful Plus, with the medical device 10, there is no build-up of waxes or gels when the mouth 2 is unwired, yielding hygienic results after removal of the hardware 8. The medical device 10 can also be cut to shape and used in different locations of the mouth 2 where comfort is especially needed as well.

The medical device 10 can hinder or even prevent any acid from food and/or drink from burning the gums 6 of the patient. Also, the medical device 10 can be used by surgeons after surgery by packing the medical device 10 into the mouth 2 of the patient for immediate comfort thereof and/or absorption of blood therein.

The medical device 10 has been described above in an illustrative manner. Those having ordinary skill in the related art should appreciate that the terminology that has been used above is intended to be in the nature of words of description rather than of limitation. Many modifications and variations of the medical device 10 are possible in light of the above teachings. Therefore, within the scope of the claims appended hereto, the medical device 10 may be practiced other than as so described.

What is claimed is:

1. A wired-mouth-protection medical device comprising:
at least one flexible material pad that defines a pair of opposed faces and is configured to be positioned between and in operative resting contact with a plurality of teeth and gums of a surgical patient and surgical hardware attached to at least one of the teeth and gums such that the pad wraps about a front of top and bottom sets of the teeth and gums in a “wired mouth” state of the patient and acts as a barrier between at least one surgical wound of at least one of the teeth and gums and the surgical hardware, the pad defining further an air hole that is configured to allow the patient to breathe through the pad.

2. The medical device of claim 1, wherein the pad defines arcuate ends.

3. The medical device of claim 1, wherein a thickness defined by the pad is small relative to each of a length and width defined by the pad.

4. The medical device of claim 1, wherein the pad is pillowy.

5. The medical device of claim 4, wherein only one of the faces is pillowy.

6. The medical device of claim 4, wherein both of the faces is pillowy.

7. The medical device of claim 1, wherein at least one of the faces of the pad is water-resistant.

8. The medical device of claim 1, wherein the pad includes velvet.

9. The medical device of claim 1, wherein the pad includes foam.

10. The medical device of claim 9, wherein the foam includes medical foam.

11. The medical device of claim 9, wherein the foam includes latex foam.

12. The medical device of claim 1, wherein the air hole is defined in a substantially central area of the pad.

13. The medical device of claim 1, wherein the air hole is defined through an entirety of the pad.

14. The medical device of claim 1, wherein the air hole is substantially rectangular.

15. The medical device of claim 1, wherein the air hole defines arcuate ends.

16. The medical device of claim 1, wherein the air hole is substantially concentric, congruent, and symmetrical with respect to the pad.

17. The medical device of claim 1, wherein a surface area defined by the air hole is small relative to that defined by the pad.

18. The medical device of claim 1, wherein the medical device defines at least one indentation that is configured to receive a corresponding frenulum of the patient.

19. The medical device of claim 1, wherein the medical device comprises a pair of pads.

20. The medical device of claim 19, wherein the pads are disposed in a “back-to-back” relationship with each other.
